(19) United States
(12) Patent Application Publication
(10) Pub. No.: US 2014/0230484 A1
(43) Pub. Date: Aug. 21, 2014

(54) FOODSERVICE PRODUCT WITH A PCM

(71) Applicant: EDWARD YAVITZ, LOVES PARK, IL (US)

(72) Inventor: EDWARD YAVITZ, LOVES PARK, IL (US)

(21) Appl. No.: 13/769,379

(22) Filed: Feb. 17, 2013

(51) Int. Cl. A47G 19/22; C09K 5/06

(52) U.S. Cl. CPC A47G 19/2288; C09K 5/063
USPC 62/457.4; 126/400

(57) ABSTRACT

A single use multi-layered food service product such as paper cups, food containers, or sleeves constructed of materials including at least one phase changing material (PCM) with one or more additives to produce a thermal conductivity ratio of at least 2.0 W/mK and a melting point between 45 degrees C. and 80 degrees C. An inventive pattern for the placement and distribution of the PCM within its multilayered walls is described. The PCM is configured in order to minimize manufacturing cost and environmental impact while providing insulation and maximizing its ability to rapidly reduce and then maintain a safe and preferred temperature for served food or beverages.

US Class 99/483; 220/62.11,62.12,62.13; 229/100; 493/906, 907

Field of search: 99/483; 220/62.11,62.12,62.13; 229/100; 493/906, 907

### U.S. PATENT DOCUMENTS

| | | |
|---|---|---|
| 3,737,093 | June 1973 | Amberg |
| 4,435,344 | March 1984 | Iioka |
| 4,528,329 | July 1985 | Inoue |
| 5,205,473 | April 1993 | Coffin |
| 5,490,631 | Febuary 1996 | Iioka |
| 5,626,945 | May 1997 | Berzins |
| 5,635,279 | June 1997 | Ma |
| 5,654,039 | August 1997 | Wenzel |
| 5,660,900 | August 1997 | Andersen |
| 5,683,772 | November 1997 | Andersen |
| 5,718,835 | Febuary 1998 | Momose |
| 5,826,786 | October 1998 | Dickert |
| 5,837,383 | November 1998 | Wenzel |
| 5,843,544 | December 1998 | Andersen |
| 6,379,497 | April 2002 | Sandstrom |
| 6,536,657 | March 2003 | Van Handel |
| 6,729,534 | May 2004 | Van Handel |
| 6,852,381 | Febuary 2005 | Debraal |
| 6,919,111 | July 2005 | Swoboda |
| 7,841,974 | November 2010 | Hartjes |
| 7,980,450 | July 2011 | Swoboda |
| 8,016,980 | September 2011 | Fike |
| 8,146,796 | April 2012 | D'Amato |
| 8,333,903 | December 2012 | Rolland |
| 20070012066 | January 2007 | Kaplan |
| 20110248208 | October 2011 | Rolland |
| 20100314397 | December 2010 | Williams |

### OTHER REFERENCES

Mehling, S. Hiebler, F. Ziegler, Latent heat storage using a PCM-graphite composite material, Proceedings of Terrastock 2000—8th International Conference on Thermal Energy Storage, Stuttgart (Germany) (2000), pp. 375-380.

Py et al. Paraffin/porous-graphite-matrix composite as a high and constant power thermal storage material, Int. J. Heat Mass Transfer 44 (2001) 2727-2737

Wang et al. The Investigation of thermal conductivity and energy storage properties of graphite/paraffin composites, Journal of Thermal Analysis and Calorimetry (2012) 107:949-954.

### FIELD OF INVENTION

The present disclosure generally relates to single-use paper products for the food service industry which incorporate phase changing materials in a unique pattern.

### BACKGROUND

Insulated disposable foodservice beverage and food containers are ubiquitous. The insulation prevents the consumer from burning their hands while preventing ambient air temperatures to cool the served food or beverage. Unfortunately, food and particularly drink is often dispensed at scalding temperatures requiring all manner of warnings. Insulation simply prolongs the time period during which the comestible is dangerously hot causing burns to the tongue, throat and buccal mucosa, such as the dreaded “rooflimation” burn to the roof of the mouth described at Harvard Medical School in a 1975 student play co-authored by the present inventor (unpublished). The object of the present invention is to both insulate and actively reduce and maintain the temperature of the food or drink at a preferred serving temperature.

One of the most widely accepted types of heat-insulating paper-based food containers include those described in U.S. Pat. No. 4,435,344, and also referred to in U.S. Pat. No. 5,490,631. Both aforementioned patents are incorporated herein in their entirety and describe low cost cups having good insulting properties. Such cups are fabricated from a body member and a bottom member, both cut from a paper sheet. One surface of the body member is coated or laminated with a thermoplastic synthetic resin film, and the other surface of the body member is coated or laminated with the same or different thermoplastic synthetic resin film or an aluminum foil, to thereby foam the thermoplastic synthetic resin film and form a heat-insulating layer on at least one surface of the container, usually the outer surface. Water present in the paper is vaporized upon heating during processing, causing the thermoplastic resin film on the outer surface to foam. U.S. Pat. No. 7,980,450 also incorporated herein in its entirety teaches a method of incorporating waxes such as paraffin into the paperboard material out of which containers such as paper plates are made. This wax-infused paperboard is then coated with an inorganic clay coat then an acrylic coat. Paraffin is a good insulator because it is a poor heat conductor and in its solid state adds rigidity and strength to the paper plates. Paraffin has been used to coat paper cups for the same purposes of insulation, waterproofing, grease resistance and rigidity. In U.S. Pat. No. 6,919,111, to Swoboda et al., a cellulosic multi-ply paperboard is described that contains predominantly cellulosic fibers, a bulk and porosity enhancing additive, and a size press applied binder coating. The paperboard can be coated with either a binder, such as poly(vinyl alcohol), or with a wax. A similar composition having a coating of either a binder such as poly(vinyl alcohol) or a wax is described in U.S. Pat. No. 6,379,497, to Sandstrom et al. In U.S. Pat. No. 5,843,544 to Andersen et al., hinged starch-bound cellular matrix clam-shell type containers are described that can be coated on the interior with a wax coating. The container can also be coated on the exterior with an elastomeric coating that can comprise poly(vinyl alcohol) in order to strengthen the outer surface and reduce its tendency to fracture during the hinging action. Similar articles produced from a starch-bound cellular matrix reinforced with dispersed fibers and having optional coatings of materials such as poly(vinyl alcohol) or wax are discussed in U.S. Pat. Nos. 5,660,900 and 5,683,772 to Andersen et al. Wenzel et al., in U.S. Pat. Nos. 5,654,039 and 5,837,383, describe recyclable and compostable coated paper stock comprising a substrate having a primer coat that can be poly(vinyl alcohol) and, in addition, having a top coat that can include a wax composition, which can be a paraffin wax. In U.S. Pat. No. 5,626,945 to Berzins et al. and U.S. Pat. No. 5,635,279 to Ma et al., water repellant paperboard is described that has a coating comprising a wax component that can be a paraffin wax, mixed with a polymer matrix of polymer chains ionically cross-linked through pendant carboxylate groups.

Waterproofing and insulating characteristics are also found in food containers made of or coated with Polyethylene (PE), Polystyrine (PS), polypropylene (PP), elastic polyurethane, and polyethylene terephthalate (PET); however these fuel-based plastics are currently in disfavor because they are not easily biodegradable. Polylactic acid (PLA) a more expensive biodegradable biopolymer made by Natur-Tec of Circle Pines, Minn. which has similar advantageous characteristics and is being used to create paper food service products. U.S. Pat. No. 8,016,980 incorporated herein in its entirety describes the use of PLA as one filler inside multi-layered paperboard. U.S. Pat. Nos. 7,841,974, 6,536,657 and 6,729,534 and U.S. Patent Publication No. 2005-0029337, which disclosures are incorporated herein in their entireties by this reference, disclose beverage containers having a film adhered to the interior thereof. When the container is filled with a hot liquid, the film will shrink. Upon shrinking, the film moves away from the interior of the container to create a pocket of air. This air pocket results in the container having insulating characteristics. Other types of multilayer insulating cups are known. For example, U.S. Pat. Nos. 3,737,093 , 5,205,473 and 8,146,796 which disclosures are incorporated herein in their entirety by this reference, describe a multiwalled cup which creates an air space for thermal insulation. The '796 patent describes an outside wall and perimeter wall joined at the upper and lower ends so that said heat-insulating gap is closed. U.S. Pat. No. 4,435,344, which disclosure is also incorporated in its entirety by this reference, describes a container made from foam polyethylene-coated paperboard which has insulating properties. More recently, U.S. Pat. No. 6,852,381, which disclosure is incorporated herein in its entirety by this reference, describes an insulated beverage container comprising (in order from the outermost surface to the inside of the container): a paperboard outer shell, a foam layer laminated to the inner surface of the paperboard shell and a film adhered to the foam surface. U.S. Pat. No. 5,826,786, also incorporated herein by this reference teaches a paper sleeve made to insulate hot liquid cups using an embossed spacing to create air spaces which act as an insulating layer between the outside surface of the sleeve and the sides of a cup inserted against the inside surface of the sleeve.

While the above references disclose a number of different configurations and compositions for insulating food and beverage containers, there remains a need in the art for a food service paper product that not only provides suitable insulating properties but actively and rapidly at first absorbs heat which quickly cools contacted food or liquid from a scalding to a more desirable temperature, stores that thermal energy and later releases the heat and transfers it back to the food or liquid allowing it to maintain a desirable temperature longer than with current containers that simply insulate. The present invention meets such a need by incorporating at least one phase changing material (PCM) into the composition of the food service product.

PCMs are well known to have the ability to absorb, store and later release heat as they change from solid to liquid as they reach their melting point, then return to a solid phase as they cool. PCM materials are highly effective thermal storage media which are capable of absorbing and releasing high amounts of latent heat during melting and crystallization, respectively. During such phase changes, the temperature of the PCM materials remains nearly constant and so does the space surrounding the PCMs, the heat flowing through the PCM being “entrapped” within the PCM itself.

One commercially available use of a PCM for use in hot beverages is the Coffee Joulie (http://www.joulies.com) which is a reusable PCM contained in a stainless steel shell meant to be dropped into a cup of coffee. The PCM absorbs heat by liquifying above 140 F thus cooling the beverage and subsequently solidifies, transferring some of its heat back to the beverage. It has several glaring shortcomings which the present invention solves. First, the devices are very expensive and can be lost. Secondly, in use they are obscured by the opaque coffee and can be inadvertently inhaled causing asphyxiation. Finally, they are not compostable or easily recycled. Williams et al in US Pat application 20100314397 incorporated herein by reference describes a reusable packaging system using segments containing two or more different PCMs with different melting points that bracket a temperature sensitive payload's intended temperature. It is too expensive to be useful as a single use foodservice container and unlike the present invention it requires assembly by the user. Furthermore, the location and placement of the segmented PCM panels in the Williams application prevents the PCM from migrating and changing its location during use, which will be shown to be a key advantage of the present invention.

An inexpensive PCM with melting points in the range required by this invention of between 45 and 80 degrees Celsius and more preferably the ideal drinking and eating temperature of between 50 and 65 degrees Celsius is Paraffin. The number of carbon atoms of a paraffinic hydrocarbon correlates with its melting point. For example, n-Octacosane, which includes 28 straight-chain carbon atoms per molecule, has a melting point of about 61.5 degrees Celcius. Rubitherm GmB commercially supplies paraffin with precise melting temperatures at 40 C (RT40), 50 C (RT50), 60 C (RT60), 65 C (RT65), 70 C (RT70), and 80 C (RT80). Any PCM with a melting point above that would maintain liquid at a temperature above 180 F which is too hot to drink and may result in burns.

A major shortcoming of paraffin is poor heat conductivity. In both its solid and liquid phase it acts more as an insulator than a heat conductor with a thermal conductivity ratio of 0.2 W/mK. Another problem is that paraffin takes less than 4 minutes depending on ambient temperatures to recrystallize from a liquid state as its temperature falls below its melting point. Consumers would prefer to take longer to finish a cup of coffee or a meal. These shortcomings can be solved by using a composite of paraffin with a high heat transfer element such as graphite. Scientific studies of such paraffin/graphite compounds which are incorporated herein by reference include: Mehling, S. Hiebler, F. Ziegler, Latent heat storage using a PCM-graphite composite material, Proceedings of Terrastock 2000—8th International Conference on Thermal Energy Storage, Stuttgart (Germany) (2000), pp. 375-380. and Py et al. Paraffin/porous-graphite composite as a high and constant power thermal storage material, Int. J. Heat Mass Transfer 44 (2001) 2727-2737 and Wang et al. The Investigation of thermal conductivity and energy storage properties of graphite/paraffin composites, Journal of Thermal Analysis and Calorimetry (2012) 107:949-954, Wang showed that a composite of paraffin and micron-size graphite flakes (MSGFs) in concentrations above 1% by weight delays the solidification rate of the paraffin from 250 seconds to more than 500 seconds and increases the thermal conductivity tenfold from 0.2 to over 2.0 (W/mK). This translates into 8 minutes or more of thermal stability for the food or beverage in contact with this material.

### SUMMARY OF THE INVENTION

The purpose of the invention is to offer a multi-layered food service product improved in the disadvantages mentioned above, for use as paper cups, food containers, sleeves or mats. This product includes at least one phase changing material (PCM) with a melting point between 45 and 80 degrees, preferably between 60 and 75 degrees Celsius combined with one or more additives to produce a thermal conductivity ratio of at least 2.0 W/mK. It has an inventive pattern for the placement and distribution of the modified PCM within its multilayered walls. The PCM is configured in order to minimize manufacturing cost and environmental impact while providing insulation and maximizing its ability to rapidly reduce and then maintain a safe and preferred temperature for served food or beverages.

### BRIEF DESCRIPTION OF THE DRAWINGS

Other and further objects and advantages of the present invention will become apparent in the following description when taken in connection with the accompanying figure in which:

FIG. 1 is a is a cross section of the lowest aspect of an exemplary multi-layered food service product with the outermost layer opened to reveal the next closest layer to the food or beverage.

FIG. 2 is a graph showing the change in temperature of hot coffee over time served by a Starbucks restaurant and held in a standard paper cup (line A) versus a second cup of the same coffee in the same standard paper cup thermally integrated with a multilayered sleeve created according to the present invention (line B).

### DETAILED DISCUSSION OF THE INVENTION

For the purposes of this disclosure the following definitions apply:

“Foodservice product” means a single use product in direct or thermal contact with comestibles and beverages including but not limited to cups, containers, French fry boxes. Clam shells, pizza boxes, coffee cup sleeves, and food placemats.

Because the invented food service product depends upon thermal conduction from a PCM to the contents of a foodservice container it does not matter if the PCM is incorporated into the walls of the immediate container in direct contact with the food or beverage or into the structure of a sleeve or placemat which itself is in direct contact with the foodservice container and therefore thermally integrated with the container. “Thermally integrated” and in direct “thermal contact” will mean the same thing for the purposes of this disclosure. For example in the case of a ceramic mug, where the walls are solid, a surrounding annular tapered sleeve with opened top and bottom ends for inserting a cup or mug therein can be made according to the present invention and would absorb and then return heat through the normally highly heat conductive walls of the ceramic mug. All descriptions of the container walls in the present invention apply equally to a sleeve or a placemat which becomes thermally integrated with a food or beverage container wall when it is in contact and is therefore understood to be in “thermal contact” and capable of thermal exchange with the food or beverage therein. Furthermore, the “innermost” layer of the multilayered product disclosed herein will refer to that layer closest to the food or beverage, and the “outermost” layer will refer to that layer farthest away from the food or beverage.

The expression “mixing by mechanical means” means agitating, mixing or kneading of the heat storage component and various other components or additives in a state in which the components are made flowable and deformable under the action of an external force by being subjected to a high temperature or by causing the melt of at least one of these components at least to swell the other components therewith or preferably to dissolve the other components therein. The PCM composition according to the present invention can be produced by soaking the different components all together at temperatures which are slightly above the melting point of the PCM but below the melting point of the one or more additives. Soaking is a natural absorption of the molten PCM by an additive such as graphite, metals or a polymer matrix. Usually the components are mixed together in a heated tumble blender during a certain period of time which can vary in function of the rotational speed of the tumble blender and its temperature.

“PCM” means a phase changing material or a polymer or mixture containing a phase changing material and one or more other additives.

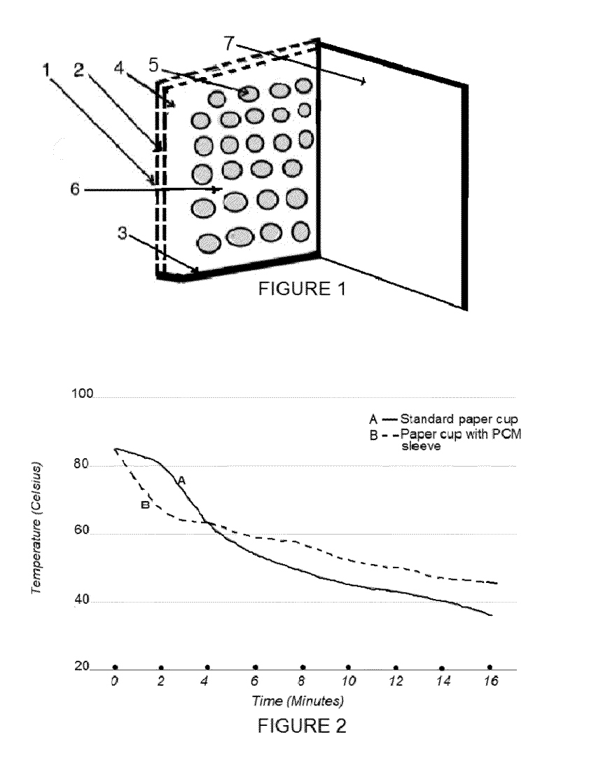

In a preferred embodiment, the food service product (FIG. 1) has one or more innermost layers of a waterproof (1) and heat conductive (2) substrate material. Liquid or grease impervious barriers well known in the art can be applied during manufacture to the surface of any food service product which will be in direct contact with food or drink. This material can be made of a waxed paper comprised of a porous sheet material made of a cellulosic material, or a cellulose-based material. Such well known paper sheet materials include, for example, corrugated paperboard (or “cardboard”), Kraft paper stock, pan liner paper stock, and the like. In addition to paper and paper-like materials, other cellulose-based sheet materials, such as pressed board, may also be suitable. The paper products are made waterproof in a number of ways well known in the art such as adding a wax or plastic coating. It is also possible to use other materials for the substrate sheet material including but not limited to Polyethylene (PE), polypropylene (PP), elastic polyurethane, polyethylene terephthalate (PET), and Polylactic Acid (PLA). An aluminum foil or aluminized polyester plastic could also act a waterproof and highly heat conductive substrate material for this layer. It should be noted that traditionally used materials with a high degree of insulation or low thermal conductivity such as polystyrene (PS) or foamed PLA should not be used for the innermost layer, because they would prevent an adequate heat exchange between the served food or beverage and the PCM contained in the present invented food service product.

The food service product may be formed into a shaped article by means well known in the art such as folding and gluing, or by pressure-forming. Such shaped articles may be used for microwave cooking purposes or used to form a singe use food receptacle such as a clamshell. Or the foodservice product material may be used for fast-food containers, such as coffee cups, boxes for pizza, hamburgers, fried chicken, or food wrappers, such as wrapping materials for sandwiches. Or it can be formed in the shape of an annular tapered sleeve with opened top and bottom for inserting a cup therein. An especially preferred embodiment would be a sleeve for a cup or mug which has an elastic component to ensure a tight fit to the cup or mug. Thus, the foodservice product may be used for any of a variety of applications as a food container, wrapper, sleeve or receptacle. It can also be used in placemats to keep served food warm.

The food service product shown in FIG. 1 is multilayered and is sealed at its perimeter (3) using sealing methods known to those in the art such as heat sealing or glueing. Looking outward from the innermost heat conductive layers (1, 2) are one or more layers (4) that function as a heat exchanger by virtue of containing a Phase Changing Material (PCM) (5) having a useful melting point at the preferred eating temperature for food and beverage of between 45 and 80 degrees Celsius. Useful PCMs for this purpose includes one or more of paraffin, polyolefins, Rubitherm RT40,RT50,RT60,RT65,RT70, N-Pentacosane, Tristearin, N-Hexacosane, N-Octacosane, Palmitic acid, and Bees wax. Despite having a melting point at the preferred eating temperature for food and beverage of between 45 and 80 degrees Celsius, the limitation of poor thermal conductivity for pure paraffin (having a thermal conductivity of 0.2 W/mK) and several of the other PCMs listed above is surprisingly overcome by combining the PCM with one or more additives having a thermal conductivity above 50 W/mK in an amount as minimal as 1 to 5 percent by volume. These higher thermal conductivity materials include 1 to 15 micron sized particles of one or more of the following materials: ceramics, aluminum, silicon carbide, zinc, copper and graphite. The resulting PCM plus additive, increases its thermal conductivity by at least tenfold to greater than 2.0 W/mK. The additives and PCM are mixed by mechanical means well known to those in the art. For environmental and economic reasons, graphite is the preferred additive; however, many other substances or combinations of substances with high thermal conductivity well known to those in the art can be used.

In the preferred embodiment shown in FIG. 1, the layer or layers of the food service product containing a PCM has the PCM in its solid state at room temperature comprising 10 to 70 percent of the volume of the heat exchanging layers, arrayed in a non continuous pattern leaving communicating air filled spaces (6) between the substrate layer on which the PCM is deposited and the outermost layer (7) of the food service product. These spaces communicate with each other and allow an otherwise stiff hard PCM-filled food service container to be flexibly folded during manufacture into a cylinder or other container shape such as a French fry box. In addition, the partial filling of the heat exchanging layer with PCM saves cost and reduces the environmental impact during disposal compared to complete filling while surprisingly, increasing its effectiveness. In service, a hot food or beverage in thermal contact with the invented food service product melts the PCM in its heat exchanging layers which flows by gravity through communicating air filled spaces where it coalesces in the lower aspects of the cup or container to keep the remaining contents at a constant desired temperature even as time passes and the contents are consumed and their level drops within the container.

If the PCM was continuous instead of discontinuous in the PCM layer and completely filled the PCM layer, as in a thermal wall now commonly seen in the construction industry, it would cost much more in materials and being unable to migrate, the trapped PCM would dissipate heat wastefully to empty areas of the container as the level of food or drink dropped during its consumption. The invented communicating air filled spaces between the segments of PCM in the PCM layer allow the PCM, once liquefied by the heat of the contacted food or beverage, to flow by gravity into the air filled spaces and to coalesce to form a continuous area of PCM in the lower aspects of the foodservice product.

This novel arrangement of PCM and air filled spaces provides maximal thermal stability to the remaining contents as the food or beverage is consumed and its level within the container falls.

Sealing the perimetry of the paper product in one of many ways known in the art prevents the liquified PCM from leaking

A number of different patterns of discontinuous placement of PCM segments in the PCM space during the manufacturing process are acceptable including but not limited to alternating vertical strips and vertical spaces from top to bottom, herringbone patterns, or evenly spaced dots of PCM. A final advantage of air filled spaces in the PCM layer is that they provide insulation, thus reducing or eliminating the need for added external insulating foam or cardboard jackets or other layers, although the outermost layer (7) of the invented product shown in FIG. 1 can be made of materials with a high degree of insulation or low thermal conductivity such as polystyrene (PS) or foamed PLA or added insulation and to prevent the heat from the heat exchange layer(s) from reaching the consumer or dissipating into the ambient cold air surrounding the food service product.

In an exemplary use, the food service product thus described is formed into the shape of a cup. When it is filled with a serving of hot coffee, the PCMs in the walls of the cup actively and rapidly at first absorb heat by changing from a solid to a liquid above its melting point, which quickly cools the coffee from a scalding to a more desirable temperature. Unlike with purely insulating cups, the invented cup allows a consumer to drink the coffee almost immediately without requiring them to test the temperature and suffer mouth and tongue burns. The liquified PCM stores thermal energy and later as it cools below its melting point and begins to change back to a solid, it releases its stored thermal energy, transferring it by thermal conduction through the conductive innermost layers back to the coffee allowing it to maintain a desirable temperature far longer than through insulation alone. The invented pattern of placement of the PCM in the heat exchanging layer(s) allows the PCM to flow in its liquid state by gravity to form a coalesced layer near the bottom of the cup, increasing the volume and area of contact of hot PCM with the coffee remaining in the cup. Thus, as the coffee is drunk and its level in the cup falls, and despite the passage of time, the coffee remains at or near the melting point temperature of the PCM layer instead of turning cold before it is fully consumed.

FIG. 2 is a plot of the temperature over time of coffee actually served by a local Starbucks restaurant in the paper cup supplied by the restaurant vs. the same coffee placed in a paper cup surrounded by a sleeve made according to the present invention as described in the following example.

### EXAMPLE

Natural graphite flakes supplied by Consolidated Chemical of Allentown, Pa. and having a diameter of 5 microns and a thermal conductivity of over 50 W/mK was combined with paraffin with a melting point of 65 degrees C. supplied by WR Medical of Maplewood, Minn., by first melting the paraffin in an ultrasound water bath heated to 79 degrees Celsius and then adding the graphite in an amount of 3% by volume into the ultrasound bath. This caused a uniform dispersion of the graphite in the melted paraffin. The melted composite PCM was then placed as equally spaced strips inside a polyethylene Ziplock bag from SC Johnson of Wisconsin using a 5 cc syringe supplied by Becton-Dickinson of Franklin Lakes, N.J. and allowed to cool to a solid state. The perimeter edge of the plastic bag was sealed and the bag was wrapped around an empty Starbucks paper cup as a sleeve and taped to itself to keep it in place. Two cups of hot coffee were ordered from a local Starbucks and one cup was immediately transferred to the modified Starbucks paper cup of the present invention. The temperature of both the treated and untreated cups was measured and recorded with a digital thermometer from Taylor Precision Products of Oak Brook, Ill. and a measurement was recorded every minute. The coffee was sipped away beginning when it's temperature fell to a non-scalding temperature of under 70 degrees C. at rate of one sip per minute. The time and temperature curve is plotted on the graph of FIG. 2 as line (A) for the untreated cup and as line (B) for the cup with the thermally integrated food service product of this invention. It can be seen that the standard cup was too hot to drink for a full 3 to 4 minutes, followed by rapid cooling, allowing consumption at the rate of one sip per minute for only 9 minutes before it had cooled to an undesirable level below 45 degrees C. The coffee thermally connected to the invented product cooled to a drinkable temperature of 70 degrees C. within the first minute and maintained a satisfying temperature above 45 degrees C. longer than the standard paper cup, allowing for 16 minutes of enjoyable consumption.

Numerous modifications and variations may be made in light of the principles of the invention disclosed above without departing from its teachings. The invention and all modifications and variations thereof are included within the definition of the following claims.

I claim:

1. A multilayer paper or plastic food service product sealed at its perimeter that actively and rapidly at first absorbs thermal energy which quickly cools thermally contacted food or liquid from a scalding to a more desirable temperature, stores that thermal energy and later releases and transfers it back to the thermally contacted food or liquid to maintain a desirable temperature for consumption.

2. The food service product of claim 1 which incorporates at least one phase changing material (PCM).

3. The PCM of claim 2 which includes one or more of polyolefins, Rubitherm RT40, RT50, RT60, RT65, RT70, RT 80, N-Pentacosane, Tristearin, N-Hexacosane, N-Octacosane, Palmitic acid, and Bees wax.

4. The PCM of claim 2 containing between 1% and 5% by volume of between 1 and 15 micron sized particles of an additive having a thermal conductivity of greater than 50 W/mK including but not limited to one or more of ceramics, aluminum, zinc, copper, silicon carbide or graphite.

5. The PCM of claim 2 having a melting point between 45 degrees and 80 degrees Celsius, preferably between 60 an 70 degrees Celsius.

6. The PCM of claim 4 which transfers heat from and to thermally contacted food or beverage in order to maintain the temperature of the food or beverage at or near the melting point of the PCM.

7. A multilayered food service product sealed at its perimeter that actively and rapidly at first absorbs thermal energy which quickly cools thermally contacted food or liquid from a scalding to a more desirable temperature, stores that thermal energy and later releases and transfers it back to the thermally contacted food or liquid allowing it to maintain a desirable temperature containing in at least one layer a discontinuous arrangement of at least one phase changing material (PCM) incorporating one or more additives to produce a thermal conductivity ratio of at least 2.0 W/mK. and a melting point between 45 degrees C. and 80 degrees C.

8. The PCM of claim 7 which includes one or more of polyolefins, Rubitherm RT40, RT50, RT60, RT65, RT70, RT 80, N-Pentacosane, Tristearin, N-Hexacosane, N-Octacosane, Palmitic acid, and Bees wax.

9. The PCM additives of claim 7 comprising between 1% and 5% by volume of between 1 and 15 micron sized particles having a thermal conductivity of greater than 50 W/mK including but not limited to one or more of ceramics, aluminum, zinc, copper, silicon carbide or graphite.

10. The discontinuous arrangement of at least one PCM of claim 7 which provides communicating air filled spaces between segments of PCM.

11. The communicating air filled spaces between segments of PCM of claim 10 which allows the PCM once liquefied by the heat of the thermally contacted food or beverage to flow by gravity into the air filled spaces and to coalesce to form a continuous area of PCM.

12. The PCM of claim 7 which transfers its stored heat as it cools to thermally contacted food or beverage in the container to maintain the temperature of the food at or near the melting point of the PCM.

13. The discontinuous arrangement of PCM of claim 7 including single or combined patterns of vertical, horizontal or oblique strips, herringbone patterns and spaced dots.

14. A single-use multilayered food service product sealed at its perimeter that actively and rapidly at first absorbs heat which quickly cools thermally contacted food or liquid from a scalding to a more desirable temperature, stores that thermal energy and later releases the heat and transfers it back to the food or liquid allowing it to maintain a desirable temperature containing in at least one layer a discontinuous arrangement of segments of at least one phase changing material (PCM) incorporating one or more additives to produce a thermal conductivity ratio of at least 2.0 W/mK. and a melting point between 45 degrees C. and 80 degrees C. connected to communicating air filled spaces between the segments of PCM.

15. The communicating air filled spaces of claim 14 which provide insulation.

16. The communicating air filled spaces between the segments of PCM of claim 14 which allow the PCM once liquefied by thermal conduction of the heat from a served food or beverage to flow by gravity into the air filled spaces and to coalesce to form a continuous area of PCM providing maximal thermal stability to the remaining contents as the food or beverage is consumed and its level within the container falls.

17. The PCM of claim 14 which transfers its stored heat by thermal conduction to a served food or beverage to maintain its temperature at or near the melting point of the PCM.

18. The layer of the foodservice product of claim 14 containing PCM whereby the PCM comprises between 10% and 70% of the total volume of the layer.

19. The multilayered food service product of claim 14 wherein the layers are composed of at least one waterproof and one heat conductive substrate material including one or more of a waxed cellulosic material, or a cellulose-based material, Polyethylene (PE), polypropylene (PP), polyethylene terephthalate (PET), elastic polyurethane, Polylactic Acid (PLA), aluminum foil or aluminized polyester.
